(19) United States
(12) Patent Application Publication
(10) Pub. No.: US 2025/0391345 A1
(43) Pub. Date: Dec. 25, 2025

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: Jun Yong SONG, Yongin-si (KR); Ji Hyun KIM, Yongin-si (KR)

(21) Appl. No.: 19/240,426

(22) Filed: Jun. 17, 2025

(30) Foreign Application Priority Data
Jun. 20, 2024 (KR) 10-2024-0080519
Aug. 7, 2024 (KR) 10-2024-0105717

(51) Int. Cl. G09G 3/32; G09G 3/3266; G09G 3/3275

(52) U.S. Cl. CPC G09G 3/32; G09G 3/3266; G09G 3/3275; G09G 2310/0267; G09G 2310/0275; G09G 2320/0285; G09G 2330/021; G09G 2330/028

(57) ABSTRACT

A display device includes a display panel including a plurality of data lines, a plurality of scan lines, and a plurality of power lines, a data driving circuit including a data driver configured to output a data signal and a scan driver configured to output a scan signal, and a power supply. The power supply is configured to supply a power voltage to the display panel through the power lines, to supply a first driving power to the data driving circuit in a first mode, and to supply the first driving power and a second driving power to the data driving circuit in a second mode different from the first mode.

### CROSS-REFERENCE TO RELATED APPLICATIONS

This application claims priority under 35 U.S.C. § 119 to Korean Patent Application No. 10-2024-0080519 filed on Jun. 20, 2024, and Korean Patent Application No. 10-2024-0105717 filed on Aug. 7, 2024, the disclosures of which are incorporated by reference herein in their entireties.

### TECHNICAL FIELD

Embodiments of the present disclosure relate to a display device and electronic device including the same.

### DISCUSSION OF RELATED ART

With the advancement of information technology, display devices, which serve as an interface between users and information, have become increasingly important. As a result, the use of display technologies such as liquid crystal displays and organic light-emitting diode displays, as well as other types of displays, has grown significantly.

Recently, high voltage has been applied to components of display devices to enable display panels to produce images with high luminance. However, this can lead to increased unnecessary power consumption.

### SUMMARY

Embodiments of the present disclosure provide a display device in which a display panel displays an image with a high luminance while reducing unnecessary power consumption.

Embodiments of the present disclosure provide a power supply, a display device, and an electronic device capable of outputting a power voltage with improved reliability by reducing a transition time of a control signal when switching a driving mode, and improving image quality of a display panel.

According to an embodiment of the present disclosure, a display device includes a display panel including a plurality of data lines, a plurality of scan lines, and a plurality of power lines, a data driving circuit including a data driver configured to output a data signal and a scan driver configured to output a scan signal, and a power supply. The power supply is configured to supply a power voltage to the display panel through the power lines, supply a first driving power to the data driving circuit in a first mode, and supply the first driving power and a second driving power to the data driving circuit in a second mode different from the first mode.

In an embodiment, the scan driver generates a first reference power and a second reference power based on the first driving power in the first mode, and generates the first reference power and the second reference power based on the first driving power and the second driving power in the second mode.

In an embodiment, the scan driver includes a first pump configured to output the first reference power, and a second pump configured to output a second reference power having a same absolute value as the first reference power.

In an embodiment, the first reference power is a sum of about twice the first driving power and the second driving power.

In an embodiment, the power supply is further configured to gradually change absolute values of the first reference power and of the second reference power at predetermined time intervals.

In an embodiment, the absolute values of the first reference power and of the second reference power change as the second driving power increases at the predetermined time intervals.

In an embodiment, each predetermined time interval is one frame.

In an embodiment, an absolute value of the second driving power is less than an absolute value of the first driving power.

In an embodiment, the data driver includes a lookup table configured to store a plurality of gamma voltages corresponding to a luminance range of an image output by the display panel, and a gamma voltage generation circuit configured to select one of the gamma voltages and output the selected gamma voltage as the data signal.

In an embodiment, the gamma voltage generation circuit includes first to n-th gamma voltage generators corresponding to n (where n is an integer greater than or equal to 1) luminance ranges, respectively.

According to an embodiment of the present disclosure, a display device includes a display panel including a plurality of data lines, a plurality of scan lines, and a plurality of power lines, a data driving circuit including a data driver configured to output a data signal and a scan driver configured to output a scan signal, and a power supply configured to supply a power voltage to the display panel through the power lines and supply a driving power to the data driving unit. The scan driver includes a first pump and a second pump configured to output a first reference power and a second reference power, respectively, based on the first driving power.

In an embodiment, the first pump is configured to output the first reference power to have a value that is about twice the driving power in a first mode, and output the first reference power to have a value that is about three times the driving power in a second mode different from the first mode.

In an embodiment, the second pump is configured to output the second reference power to have a value that is about negative twice the driving power in the first mode, and output the second reference power to have a value that is about negative three times the driving power in the second mode.

In an embodiment, the power supply is configured to control the driving power in a first mode to be less than the first driving power in a second mode different from the first mode.

According to an embodiment of the present disclosure, a display device includes a display panel including a plurality of data lines, a plurality of scan lines, and a plurality of power lines, a data driving circuit including a data driver configured to output a data signal and a scan driver configured to output a scan signal, and a power supply. The power supply is configured to supply a power voltage to the display panel through the power lines and supply a first driving power to the data driving unit, and change the first driving power in a first mode and the first driving power in a second mode different from the first mode. The scan driver includes a first regulator configured to output a high level signal of the scan signal based on the first driving power, and a second pump configured to output a second reference power based on the first driving power.

In an embodiment, the scan driver further includes a second regulator configured to output a low level signal of the scan signal based on the second reference power.

In an embodiment, the high level signal has an absolute value less than the first driving power, and the low level signal has an absolute value less than the second reference power.

In an embodiment, the power supply controls the first driving power to be greater in the second mode than in the first mode.

According to an embodiment of the present disclosure, an electronic device includes a display device and a power supply configured to provide power to the display device. The display device includes, a display panel including a plurality of data lines, a plurality of scan lines, and a plurality of power lines, and a data driving circuit including a data driver configured to output a data signal and a scan driver configured to output a scan signal. The power supply is further configured to supply a power voltage to the display panel through the power lines, to supply a first driving power to the data driving circuit in a first mode, and to supply the first driving power and a second driving power to the data driving circuit in a second mode different from the first mode.

In an embodiment, the scan driver is configured to generate a first reference power and a second reference power based on the first driving power in the first mode, and generate the first reference power and the second reference power based on the first driving power and the second driving power in the second mode.

According to embodiments of the present disclosure, a display device can be provided in which a display panel displays an image with high luminance while reducing unnecessary power consumption.

Effects according to embodiments are not limited by contents exemplified above, and more various effects are included in the present specification.

### BRIEF DESCRIPTION OF THE DRAWINGS

The above and other features of the present disclosure will become more apparent by describing in detail embodiments thereof with reference to the accompanying drawings.

FIG. 1 is a block diagram illustrating a display device according to embodiments of the present disclosure.

FIG. 2 is a circuit diagram showing an example of a pixel included in the display device of FIG. 1.

FIG. 3 is a block diagram schematically showing components of a data driving unit of the display device of FIG. 1 according to embodiments of the present disclosure.

FIG. 4 is a block diagram showing the display device of FIG. 3 in a first mode.

FIG. 5 is a block diagram showing the display device of FIG. 3 in a second mode.

FIG. 6 is a diagram showing changes in a 1_b reference power and a 2_b reference power of FIG. 5 over time.

FIG. 7 is a block diagram showing components of the data driving unit of FIG. 3.

FIG. 8 is a block diagram showing an embodiment of a display device of FIG. 3 in a second mode.

FIG. 9 is a block diagram showing an embodiment of a display device of FIG. 3 in a second mode.

FIG. 10 is a block diagram showing the display device of FIG. 1 according to an embodiment operating in a first mode.

FIG. 11 is a block diagram showing a display device of FIG. 1 according to an embodiment operating in a second mod.

FIG. 12 is a block diagram showing an electronic device including a display device according to embodiments of the present disclosure.

FIG. 13 is a perspective view showing an example of the electronic device of FIG. 12 implemented as a tablet personal computer (PC).

FIG. 14 is a perspective view showing an example of the electronic device of FIG. 12 implemented as a smartphone.

FIG. 15 is a perspective view showing an example of the electronic device of FIG. 12 implemented as a smartwatch.

### DETAILED DESCRIPTION OF THE EMBODIMENTS

Embodiments of the present disclosure will be described more fully hereinafter with reference to the accompanying drawings. Like reference numerals may refer to like elements throughout the accompanying drawings.

In this disclosure below, when it is described that an element “includes” some elements, it should be understood that it may include only those elements, or it may include other elements as well as those elements if there is no specific limitation.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. Other words used to describe the relationships between components should be interpreted in a like fashion.

Spatially relative terms such as “below,” “above,” etc. may be used for descriptive purposes, thereby describing the relationship of one element or feature to another element(s) or feature(s) as shown in the drawings. do. Spatially relative terms are intended to include different directions in use, operation, and/or manufacture in addition to the directions depicted in the drawings. For example, if the device shown in the drawings is turned over, elements depicted as being disposed “below” other elements or features may be disposed “above” the other elements or features. Accordingly, in an embodiment, the term “below” may include both above and below directions. Additionally, the device may be oriented in other directions (e.g., rotated by 90 degrees or in other orientations), and thus the spatially relative terms used herein should be interpreted accordingly.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

Embodiments of the present application provide an adaptive power management system for a display device that may decrease power consumption while maintaining high image quality. According to embodiments, a display device includes a power supply, a data driving circuit, and a display panel. The power supply may operate in multiple modes to deliver power tailored to the luminance requirements of the display. In a lower-power mode, only a first driving power may be supplied to the scan driver, enabling reduced reference power and reduced power consumption for standard image display. In a high-luminance mode, the power supply may provide both the first and second driving powers, allowing the scan driver to generate higher reference power for increased brightness. Additionally, the data driving circuit may incorporate a gamma voltage generation circuit that dynamically adjusts data signals based on image luminance, allowing for precise control of brightness and color while reducing power consumption. Thus, embodiments may enable efficient power utilization and high luminance output without compromising display quality, and may be utilized in electronic devices such as smartphones, tablets, and wearable displays.

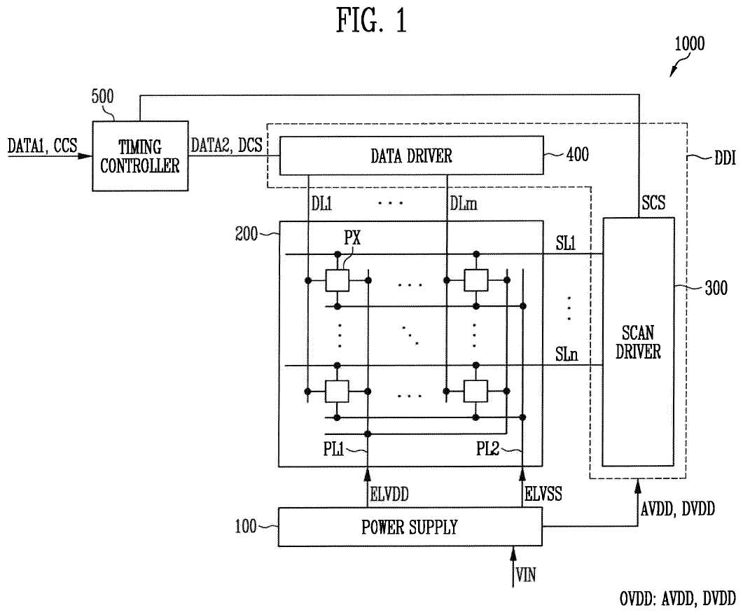

FIG. 1 is a block diagram illustrating a display device according to embodiments of the present disclosure.

Referring to FIG. 1, a display device 1000 may include a display panel 200, a data driving unit DDI (also referred to as a data driving circuit), a timing controller 500 (also referred to as a timing controller circuit), and a power supply 100 (also referred to as a power supply circuit).

The display panel 200 may include a plurality of scan lines SL1 to SLn (where n is a positive integer), a plurality of data lines DL1 to DLm (where m is a positive integer), and a plurality of pixels PX. Additionally, the display panel 200 may include a first power line PL1 and a second power line PL2.

In the present disclosure, the type of display panel 200 is not particularly limited. For example, the display panel 200 may be a self-luminous display panel. In this case, the display panel 200 may include a plurality of light-emitting elements. For example, the light-emitting element may be selected as an organic light-emitting diode. Additionally, the light-emitting element may be selected as an inorganic light-emitting diode such as a micro LED or a quantum dot light-emitting diode. Additionally, the light-emitting element may be an element composed of a composite of organic and inorganic materials.

The pixel PX may be connected to the first power line PL1, the second power line PL2, a corresponding one of the scan lines SL1 to SLn, and a corresponding one of the data lines DL1 to DLm. Hereinafter, a “connection” may refer not only to an electrical connection, but also to a physical connection, and may refer not only to a direct connection, but also an indirect connection through other components.

The pixel PX may include a light-emitting element and at least one transistor that provides a driving current to the light-emitting element.

The pixel PX may emit light with a luminance corresponding to a data voltage (or data signal) provided through a data line in response to a scan signal provided through a scan line. For example, the pixel PX disposed at the n-th row and the m-th column may emit light with a luminance corresponding to a data voltage (or data signal) provided through the m-th data line DLm in response to a scan signal provided through the n-th scan line SLn.

The data driving unit DDI may include a scan driver 300 (also referred to as a scan driver circuit) and a data driver 400 (also referred to as a data driver circuit). Although the scan driver 300 and the data driver 400 in FIG. 1 are independent from each other, embodiments are not limited thereto. For example, in an embodiment, at least one of the scan driver 300 and the data driver 400 may be formed on the display panel 200 or may be implemented as an integrated circuit (IC) and mounted on a flexible circuit board to be connected to the display panel 200. Additionally, the data driving unit DDI including the scan driver 300 and the data driver 400 may be implemented as one IC.

The scan driver 300 may generate a scan signal based on a scan control signal SCS and sequentially provide the scan signal to the scan lines SL1 to SLn. Here, the scan control signal SCS may include a scan start signal (or scan start pulse), scan clock signals, etc., and may be provided from the timing controller 500. For example, the scan driver 300 may include a shift register that sequentially generates and outputs a pulse-shaped scan signal corresponding to a pulse-shaped scan start signal (e.g., a pulse of a gate-on voltage level) using scan clock signals.

The data driver 400 may generate data voltages (or data signals) based on image data DATA2 and a data control signal DCS provided from the timing controller 500, and may provide the data voltages to the data lines DL1 to DLm. Here, the data control signal DCS may be a signal that controls an operation of the data driver 400 and may include a load signal (or data enable signal) that instructs an output of a valid data voltage.

The timing controller 500 may receive input image data DATA1 and a control signal CCS from an external source (e.g., application processor) and may generate a scan control signal SCS and the data control signal DCS based on the control signal CCS. Here, the control signal CCS may include, for example, a vertical synchronization signal, a horizontal synchronization signal, a clock signal, etc. Additionally, the timing controller 500 may convert input image data DATA1 to generate image data DATA2. For example, the timing controller 500 may convert the input image data DATA1 into the image data DATA2 having a format available in the data driver 400.

The power supply 100 according to an embodiment of the present disclosure may generate a first power voltage ELVDD and supply it to the first power line PL1, and may generate a second power voltage ELVSS and supply it to the second power line PL2 using an input power VIN. Here, the first power voltage ELVDD and the second power voltage ELVSS may be voltages utilized for operation of the pixel PX, and the first power voltage ELVDD may have a voltage level higher than the second power voltage ELVSS.

For example, the power supply 100 may be implemented as a power management integrated circuit (PMIC) and may convert the input power VIN into the first power voltage ELVDD and the second power voltage ELVSS through switching operations of transistors provided therein.

The power supply 100 may generate driving power OVDD using the input power VIN and provide the driving power OVDD to the data driving unit DDI. The driving power OVDD may include a first driving power AVDD and a second driving power DVDD.

Here, the driving power OVDD may be a voltage utilized to drive the scan driver 300 (e.g., generation of scan signals). Additionally, according to an embodiment, the driving power OVDD may be a voltage utilized to drive the data driver 400 (e.g., generation of gamma voltages).

The power supply 100 may manage a magnitude and a sequence of voltages ELVDD, ELVSS, and OVDD provided to the display panel 200 and the data driver 400 based on the input power VIN. For example, the first power voltage ELVDD and the second power voltage ELVSS may be positive and negative voltages utilized for driving the pixels PX.

According to an embodiment, the power supply 100 may implement a converter that converts the voltage of the input power VIN into the first power voltage ELVDD, and a converter that converts the voltage of the input power VIN into a third power voltage, as a boost converter. Additionally, the power supply 100 may implement a converter that converts the voltage of the input power VIN into the second power voltage ELVSS, as an inverting buck boost converter. However, this is an example and not limited thereto.

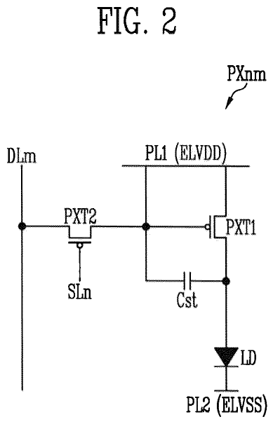

FIG. 2 is a circuit diagram showing an example of a pixel included in the display device 1000 of FIG. 1. Since the pixels PX of FIG. 1 are substantially the same as each other, the nm-th pixel PXnm included in the n-th row and m-th column will be described as representative of the pixels PX.

Referring to FIGS. 1 and 2, the nm-th pixel PXnm may be connected to the n-th scan line SLn and the m-th data line DLm. Additionally, the pixel PX may be connected between the first power line PL1 and the second power line PL2.

The nm-th pixel PXnm may include at least one light-emitting element LD, a first pixel transistor PXT1 (or a driving transistor), a second pixel transistor PXT2 (or a switching transistor), and a storage capacitor Cst. Each of the first pixel transistor PXT1 and the second pixel transistor PXT2 may include a silicon semiconductor and may be, for example, a P-type transistor. However, the first pixel transistor PXT1 and the second pixel transistor PXT2 are not limited thereto. For example, in an embodiment, at least one of the first pixel transistor PXT1 and the second pixel transistor PXT2 may include an oxide semiconductor or be implemented as an N-type transistor.

A light-emitting element LD may include at least one light-emitting component. An anode electrode of the light-emitting element LD may be connected to the first power line PL1 and a cathode electrode of the light-emitting element LD may be connected to the second power line PL2, through the first pixel transistor PXT1. The light-emitting element LD may generate light of a predetermined luminance in response to an amount of current (or driving current ID) supplied from the first pixel transistor PXT1. The light-emitting element LD may be composed of an organic light-emitting diode or an inorganic light-emitting diode such as a micro light-emitting diode (LED) or a quantum dot light-emitting diode. Additionally, the light-emitting element LD may be a light-emitting element composed of a composite of organic and inorganic materials. In FIG. 2, the nm-th pixel PXnm is illustrated as including a single light-emitting element LD, but embodiments are not limited thereto. For example, in an embodiment, the nm-th pixel PXnm may include a plurality of light-emitting elements, which may be connected in series, in parallel, or in series-parallel.

The first pixel transistor PXT1 may control the amount of driving current flowing to the light-emitting element LD in response to a voltage applied to a gate electrode. A first electrode (or first transistor electrode) of the first pixel transistor PXT1 may be connected to the first power line PL1, and a second electrode (or second transistor electrode) of the first pixel transistor PXT1 may be connected to one electrode (e.g., anode electrode) of the light-emitting element LD. The gate electrode of the first pixel transistor PXT1 may be connected to the second electrode of the second pixel transistor PXT2. The first electrode of the first pixel transistor PXT1 may be a source electrode, and the second electrode of the first pixel transistor PXT1 may be a drain electrode, but are not limited thereto.

The second pixel transistor PXT2 may be configured to receive a data voltage. For example, the first electrode of the second pixel transistor PXT2 may be connected to the m-th data line DLm. The second electrode of the second pixel transistor PXT2 may be connected to the first pixel transistor PXT1 (e.g., connected to the gate electrode of the first pixel transistor PXT1). The gate electrode of the second pixel transistor PXT2 may be connected to the n-th scan line SLn. When a scan signal at a gate-on voltage level is supplied to the n-th scan line SLn, the second pixel transistor PXT2 may be turned on, and a data voltage may be transmitted to the gate electrode of the first pixel transistor PXT1 from the m-th data line DLm.

The storage capacitor Cst may be formed or connected between one node (e.g., a node between the gate electrode of the first pixel transistor PXT1 and the second electrode of the second pixel transistor PXT2) and another node (e.g., a node between the second electrode of the first pixel transistor PXT1 and one electrode of the light-emitting element LD). The storage capacitor Cst may store the voltage (e.g., data voltage) of the gate electrode of the first pixel transistor PXT1.

Referring to FIG. 2, the nm-th pixel PXnm includes a second pixel transistor PXT2 that transmits a data voltage to an inside of the nm-th pixel PXnm, a storage capacitor Cst that stores the data voltage, and a first pixel transistor PXT1 that supplies a driving current corresponding to the data voltage to the light-emitting element LD.

However, the present disclosure is not limited thereto, and the structure of the nm-th pixel PXnm may be changed and implemented in various ways. For example, in an embodiment, the nm-th pixel PXnm may further include at least one transistor, such as a transistor that compensates a threshold voltage of the first pixel transistor PXT1, a transistor that initializes the gate electrode of the first pixel transistor PXT1, and/or a transistor that controls a light emitting time of the light-emitting element LD.

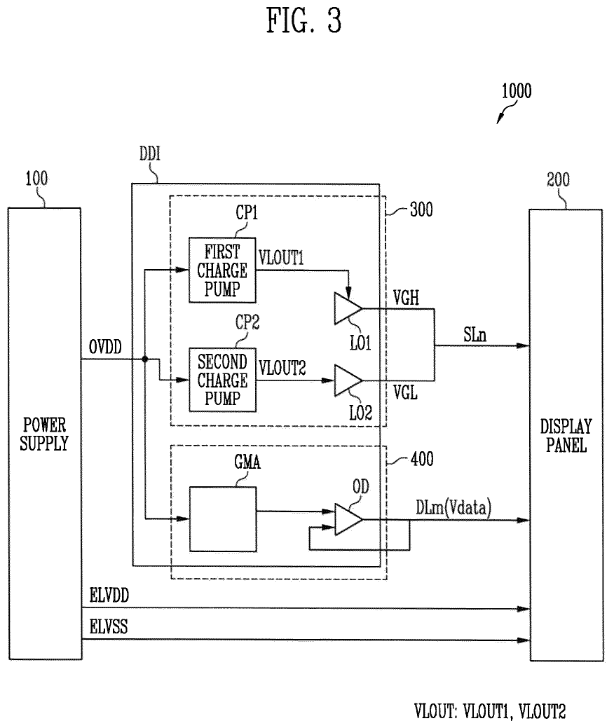

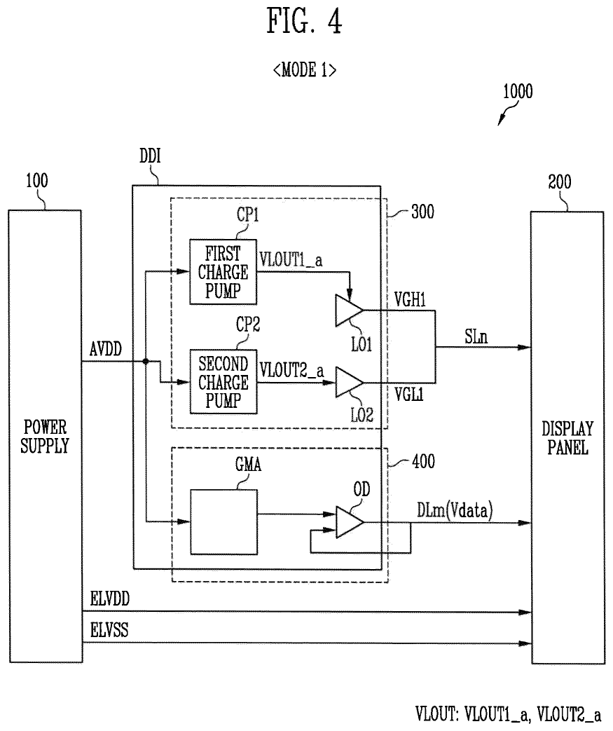

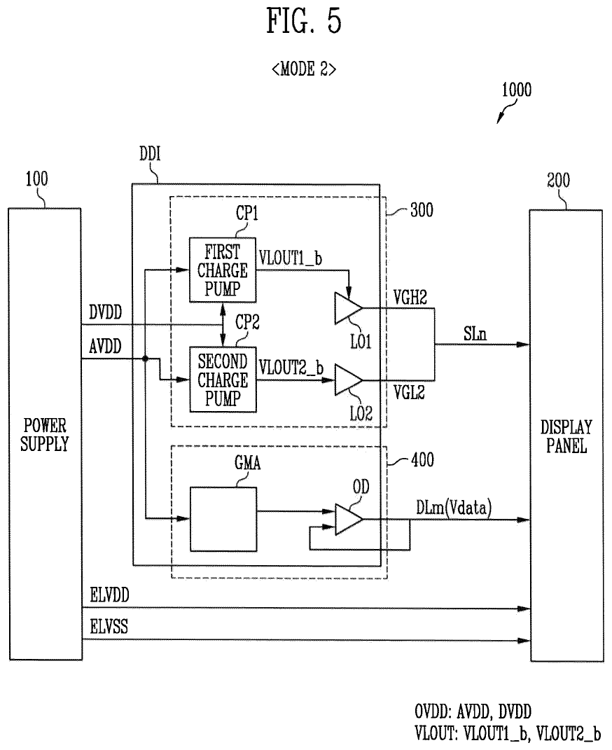

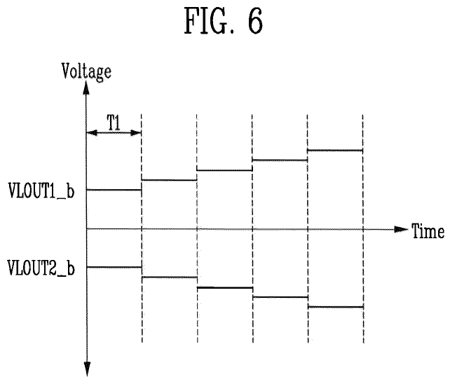

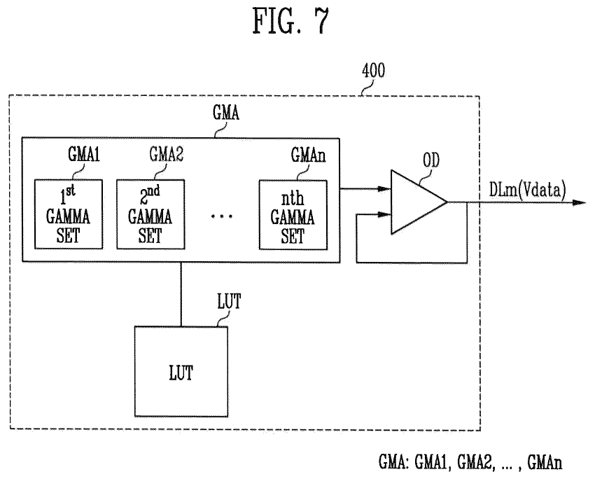

FIG. 3 is a block diagram schematically showing components of a data driving unit of the display device 1000 of FIG. 1 according to an embodiment. FIG. 4 is a block diagram showing a display device of FIG. 3 in a first mode. FIG. 5 is a block diagram showing a display device of FIG. 3 in a second mode. FIG. 6 is a diagram showing changes in a 1_b reference power and a 2_b reference power of FIG. 5 over time. FIG. 7 is a block diagram showing components of the data driving unit of FIG. 3.

Referring to FIG. 3, the power supply 100 may output the driving power OVDD to the data driving unit. Additionally, the power supply 100 may output the first power voltage ELVDD and the second power voltage ELVSS to the display panel 200.

The data driving unit DDI may receive the driving power OVDD from the power supply 100. The driving power OVDD may be supplied to each of the scan driver 300 and the data driver 400.

The scan driver 300 may include a first pump CP1 and a second pump CP2 that receive the driving power OVDD. The first pump CP1 and the second pump CP2 may output a reference power VLOUT based on the driving power OVDD. For example, the first pump CP1 may output a first reference power VLOUT1 based on the driving power OVDD, and the second pump CP2 may output a second reference power VLOUT2 based on the driving power OVDD. According to embodiments, the absolute values of the first reference power VLOUT1 and the second reference power VLOUT2 may be the same. However, embodiments are not limited thereto.

The driving power OVDD may include a first driving power AVDD and a second driving power DVDD. The second driving power DVDD may have a value about equal to or less than the first driving power AVDD. According to embodiments, the first driving power AVDD may be about 7 V. According to embodiments, the secondary driving power DVDD may be about 1.2 V or about 1.8 V.

Referring to FIGS. 3 and 4, in the first mode, the first pump CP1 may output the 1_a reference power VLOUT1_a based on the first driving power AVDD. In the first mode, the second pump CP2 may output the 2_a reference power VLOUT2_a based on the first driving power AVDD.

In the first mode, the first pump CP1 and the second pump CP2 may generate the reference power VLOUT having a value that is a multiple of the first driving power AVDD. For example, the 1_a reference power VLOUT1_a in the first mode may have a value that is about twice the first driving power AVDD. Additionally, the 2_a reference power VLOUT2_a in the first mode may have a value that is about equal to minus two times the first driving power AVDD.

Referring to FIGS. 3 and 5, in the second mode, the first pump CP1 may output the 1_b reference power VLOUT1_b based on the first driving power AVDD and the second driving power DVDD. In the second mode, the second pump CP2 may output the 2_b reference power VLOUT2_b based on the first driving power AVDD and the second driving power DVDD.

In the second mode, the first pump CP1 and the second pump CP2 may generate a reference power VLOUT having a value that is the sum of a multiple of the first driving power AVDD and the second driving power DVDD. For example, the 1_b reference power VLOUT1_b in the second mode may have a value that is the sum of twice the first driving power AVDD and the second driving power DVDD. Additionally, the 2_b reference power VLOUT2_b in the second mode may have a negative value that is the sum of twice the first driving power AVDD and the second driving power DVDD. The first mode may be a state when the display panel 200 is normally driven, and the second mode may be a state when the display panel 200 outputs an image with a high luminance.

For example, in the second mode, the first pump CP1 and the second pump CP2 may generate the reference power VLOUT as the sum of a multiple of the first driving power AVDD and the second driving power DVDD. For example, in the second mode, the 1_b reference power VLOUT1_b may be about equal to twice the first driving power AVDD plus the second driving power DVDD. Additionally, in the second mode, the 2_b reference power VLOUT2_b may have a negative value equal to about twice the first driving power AVDD plus the second driving power DVDD. The first mode represents a state where the display panel 200 operates normally, while the second mode corresponds to a state where the display panel 200 outputs an image with high luminance.

Referring to FIG. 3, the scan driver 300 may include a first regulator LO1 that outputs a high level signal VGH of a scan signal based on the first reference power VLOUT1 in the first mode. The scan driver 300 may include a second regulator LO2 that outputs a low level signal VGL of a scan signal based on the second reference power VLOUT2 in the first mode.

The first regulator LO1 and the second regulator LO2 may be configured to receive the reference power VLOUT and output a scan signal of a constant value. For example, the first regulator LO1 and the second regulator LO2 may output a scan signal to the n-th scan line SLn within a range that does not exceed the absolute value of the reference power VLOUT. That is, the value of the high level signal VGH may be less than or about equal to the value of the first reference power VLOUT1. Additionally, the absolute value of the low level signal VGL may be less than or about equal to the absolute value of the second reference power VLOUT2.

Referring to FIGS. 3 to 5, in the first mode, the first regulator LO1 may output a first high level signal VGH1 based on the 1_a reference power VLOUT1_a. In the second mode, the first regulator LO1 may output a second high level signal VGH2 based on the 1_b reference power VLOUT1_b. At this time, the second high level signal VGH2 may be greater than the first high level signal VGH1.

In the first mode, the second regulator LO2 may output a first low level signal VGH1 based on the 2_a reference power VLOUT2_a. In the second mode, the second regulator LO2 may output a second low level signal VGH2 based on the 2_b reference power VLOUT2_b. At this time, the first low level signal VGL1 may be greater than the second low level signal VGL2. In other words, each of the first low level signal VGL1 and the second low level signal VGL2 may have a negative value, and the absolute value of the second low level signal VGL2 may be greater than the first low level signal VGL1.

Meanwhile, in order for the display panel 200 to output the image with the high luminance, the absolute value of the high level signal VGH (or low level signal VGL) should be large. At this time, when the value of the first reference power VLOUT1 is increased to increase the absolute value of the high level signal VGH, unnecessary power consumption of the display device 1000 may increase. In other words, even when the display panel 200 outputs the image with the low luminance, an unnecessarily large reference power VLOUT may be generated, which can increase unnecessary power consumption of the display device 1000.

According to an embodiment of the present disclosure, unnecessary power consumption can be reduced by adaptively controlling the value of the reference power VLOUT depending on the luminance value of the image output by the display panel 200. For example, in the first mode, the power supply 100 may supply the first driving power AVDD to the scan driver 300. Accordingly, the scan driver 300 may generate a relatively low reference power VLOUT and reduce unnecessary power consumption of the display device 1000. On the other hand, in the second mode, the power supply 100 may supply the second driving power DVDD together with the first driving power AVDD to the scan driver 300. Accordingly, the scan driver 300 may generate a relatively high reference power VLOUT, and the display panel 200 may output the image with the high luminance.

According to an embodiment of the present disclosure, unnecessary power consumption may be reduced by adaptively adjusting the reference power VLOUT based on the luminance level of the image displayed by the display panel 200. For example, in an embodiment, in the first mode, the power supply 100 may provide only the first driving power AVDD to the scan driver 300, allowing the scan driver 300 to generate a relatively low reference power VLOUT and thereby reducing the display device's 1000 power consumption. In contrast, in an embodiment, in the second mode, the power supply 100 may provide both the first driving power AVDD and the second driving power DVDD to the scan driver 300. As a result, the scan driver 300 may generate a higher reference power VLOUT, enabling the display panel 200 to produce an image with high luminance.

Referring to FIGS. 3 to 5, the data driver 400 may include a gamma voltage generation circuit GMA and an output terminal OD.

The gamma voltage generation circuit GMA may generate a gamma voltage used to generate a data voltage. For example, the gamma voltage generation circuit GMA may be driven by the driving power OVDD and may generate a data voltage Vdata corresponding to a data value (or grayscale value) included in image data DATA2 (see FIG. 1). For example, the data driver 400 may select one of the gamma voltages based on the data value and may output the selected gamma voltage as a data signal to the m-th data line DLm. This will be described in further detail below with reference to FIG. 7.

Referring to FIGS. 4 to 6, the values of the 1_b reference power VLOUT1_b and the 2_b reference power VLOUT2_b may change gradually. For example, the 1_b reference power VLOUT1_b may be gradually increased at each first time interval T1. The value of the 2_b reference power VLOUT2_b may be gradually reduced at each first time interval T1.

As the second driving power DVDD gradually changes, the 1_b reference power VLOUT1_b and the 2_b reference power VLOUT2_b may change. For example, as described above, the 1_b reference power VLOUT1_b may have a value that is the sum of twice the first driving power AVDD and the second driving power DVDD. At this time, the first reference power VLOUT1_b may increase as the value of the second driving power DVDD gradually increases at each first time interval T1.

According to embodiments, the first time interval T1 may be one frame. However, embodiments are not limited thereto. For example, in an embodiment, and the first time interval T1 may correspond to, for example, 0.5 frame.

Referring to FIGS. 3 and 7, the data driver 400 may include a gamma voltage generation circuit GMA, a lookup table LUT, and an output terminal OD.

The lookup table LUT may store a luminance range (or grayscale range) of an image expressed by a display panel 200. Accordingly, the gamma voltage generation circuit GMA may read out the luminance range (or grayscale range) of the image expressed by the display panel 200 from the lookup table LUT and may generate a data signal corresponding to a luminance value (or grayscale value) included in the image data DATA2 (see FIG. 1). Thereafter, the data signal may be output to the m-th data line DLm as a data voltage Vdata through the output terminal OD.

The gamma generation circuit GMA may include the first to n-th gamma voltage generators GMA1 to GMAn. For example, the luminance range (or grayscale range) of the image expressed by the display panel 200 may be divided into n ranges. At this time, the first to n-th gamma voltage generators GMA1 to GMAn may correspond to n luminance ranges, respectively. For example, the first gamma voltage generator GMA1 may correspond to the lowest luminance range among the luminance range of the image expressed by the display panel 200, and the n-th gamma voltage generator GMAn may correspond to the highest luminance range among the luminance range of the image expressed by the display panel 200. Accordingly, the first gamma voltage generator GMA1 may read out a luminance range corresponding to a luminance value included in image data DATA2 (see FIG. 1) from the lookup table LUT and may output a data signal corresponding to the corresponding luminance range.

For example, in an embodiment, the lookup table LUT may store the luminance (or grayscale) range for images displayed by the display panel 200. The gamma voltage generation circuit GMA can retrieve this luminance range from the lookup table LUT and generate a data signal that corresponds to the specific luminance (or grayscale) value found in the image data DATA2 (see FIG. 1). This data signal may then be sent as a data voltage Vdata to the m-th data line DLm through the output terminal OD.

The gamma generation circuit GMA may include gamma voltage generators GMA1 through GMAn, each corresponding to one of n divided luminance ranges for the displayed image. For example, GMA1 may be associated with the lowest luminance range, while GMAn may handle the highest range. Accordingly, GMA1 may retrieve the luminance range for a specific luminance value in the image data DATA2 (see FIG. 1) from the lookup table LUT and output a data signal matching that range.

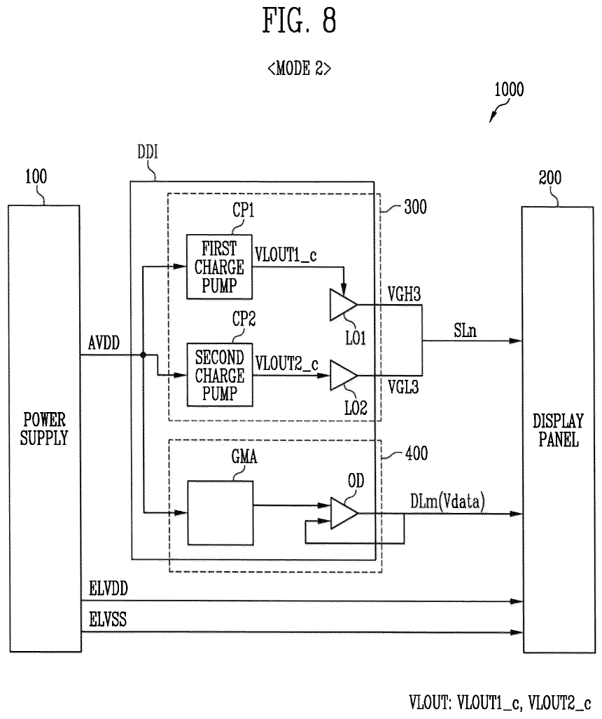

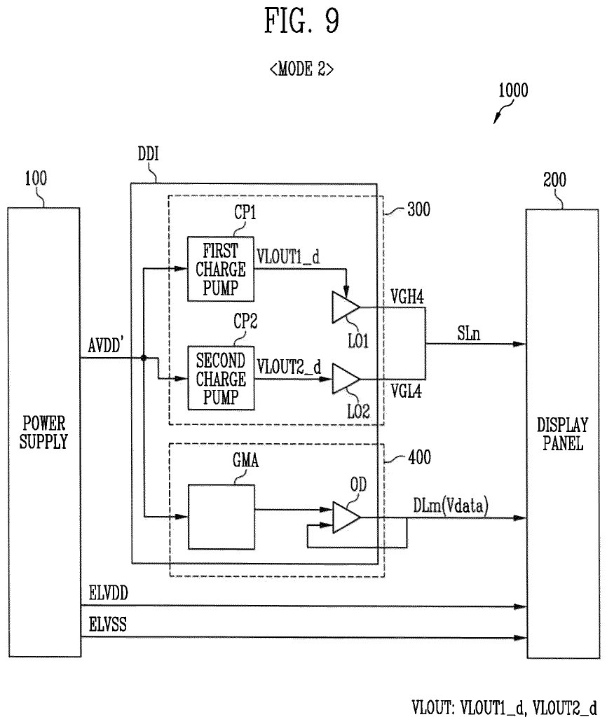

FIG. 8 is a block diagram showing an embodiment of a display device of FIG. 3 in a second mode. FIG. 9 is a block diagram showing an embodiment of a display device of FIG. 3 in a second mode.

The power supply 100 and display panel 200 of FIG. 8 may operate similarly to the power supply 100 and display panel 200 of FIG. 3. Accordingly, for convenience of explanation, a further description of components and technical aspects previously described with reference to FIG. 3 may be omitted.

Referring to FIG. 8, according to an embodiment, in the second mode, the power supply 100 may supply the first driving power AVDD to the data driving unit DDI. In other words, unlike the power supply 100 of FIG. 5, the power supply 100 of FIG. 8 may supply only the first driving power AVDD to the data driving unit DDI.

In the second mode, the first pump CP1 and the second pump CP2 may output the reference power VLOUT based on the first driving power AVDD. For example, in the second mode, the first pump CP1 may output the 1_c reference power VLOUT1_c, and the second pump CP2 may output the 2_c reference power VLOUT2_c. At this time, the first pump CP1 may output the 1_c reference power VLOUT1_c having a value that is about three times the first driving power AVDD. The second pump CP2 may output the 2_c reference power VLOUT2_c having a value that is about negative three times the first driving power AVDD. In other words, the first pump CP1 and the second pump CP2 of FIG. 8 may output the 1_c reference power VLOUT1_c and the 2_c reference power VLOUT2_c by differentiating a voltage step-up ratio from the first pump CP1 and the second pump CP2 of FIG. 5.

For example, in an embodiment, in the second mode, the first pump CP1 and the second pump CP2 may generate the reference power VLOUT based on the first driving power AVDD. For example, in this mode, the first pump CP1 may produce the 1_c reference power VLOUT1_c, while the second pump CP2 may generate the 2_c reference power VLOUT2_c. In this configuration, the 1_c reference power VLOUT1_c from the first pump CP1 may be about three times the value of the first driving power AVDD, and the 2_c reference power VLOUT2_c from the second pump CP2 may be about negative three times the first driving power AVDD.

Thus, the pumps CP1 and CP2 in FIG. 8 may produce the 1_c and 2_c reference powers VLOUT1_c and VLOUT2_c by applying a different voltage step-up ratio compared to the pumps CP1 and CP2 in FIG. 5.

According to an embodiment of the present disclosure, the scan driver 300 of FIG. 8 may output a scan signal having a relatively greater value than the scan driver 300 of FIG. 5. Accordingly, the display panel 200 of FIG. 8 may output an image with relatively higher luminance than the display panel 200 of FIG. 5. For example, the absolute values of the 1_c reference power VLOUT1_c and the 2_c reference power VLOUT2_c may be greater than the absolute values of the 1_b reference power VLOUT1_b and the 2_b reference power VLOUT2_b, respectively. Accordingly, the first regulator LO1 may output a third high level signal VGH3 greater than the second high level signal VGH2 based on the 1_c reference power VLOUT1_c. The second regulator LO2 may output a third low level signal VGL3 having an absolute value greater than that of the second low level signal VGL2 based on the 2_c reference power VLOUT2_c.

Referring to FIG. 9, the power supply 100 may receive a first driving power AVDD′. The first driving power AVDD′ of FIG. 9 may be different from the first driving power AVDD of FIG. 5. For example, the first driving power AVDD′ of FIG. 9 may have a greater value than the first driving power AVDD of FIG. 5.

In the second mode, the first pump CP1 and the second pump CP2 may output the reference power VLOUT based on the first driving power AVDD′. For example, in the second mode, the first pump CP1 may output the 1_d reference power VLOUT1_d, and the second pump CP2 may output the 2_d reference power VLOUT2_d. At this time, the first pump CP1 may output the 1_d reference power VLOUT1_d having a value that is about twice the first driving power AVDD′. The second pump CP2 may output the 2_d reference power VLOUT2_d having a value that is about negative twice the first driving power AVDD′.

According to an embodiment of the present disclosure, the scan driver 300 of FIG. 9 may output a scan signal having a relatively greater value than the scan driver 300 of FIG. 5. Accordingly, the display panel 200 of FIG. 9 may output an image with relatively higher luminance than the display panel 200 of FIG. 5. As described above, the first driving power AVDD′ of FIG. 9 may have a greater value than the first driving power AVDD of FIG. 5. Accordingly, the absolute values of the 1_d reference power VLOUT1_d and the 2_d reference power VLOUT2_d may be greater than the absolute values of the 1_b reference power VLOUT1_b and the 2_b reference power VLOUT2_b, respectively. Accordingly, the first regulator LO1 may output a fourth high level signal VGH4 greater than the second high level signal VGH2 based on the 1_d reference power VLOUT1_d. The second regulator LO2 may output a fourth low level signal VGL4 having an absolute value greater than that of the second low level signal VGL2 based on the 2_d reference power VLOUT2_d.

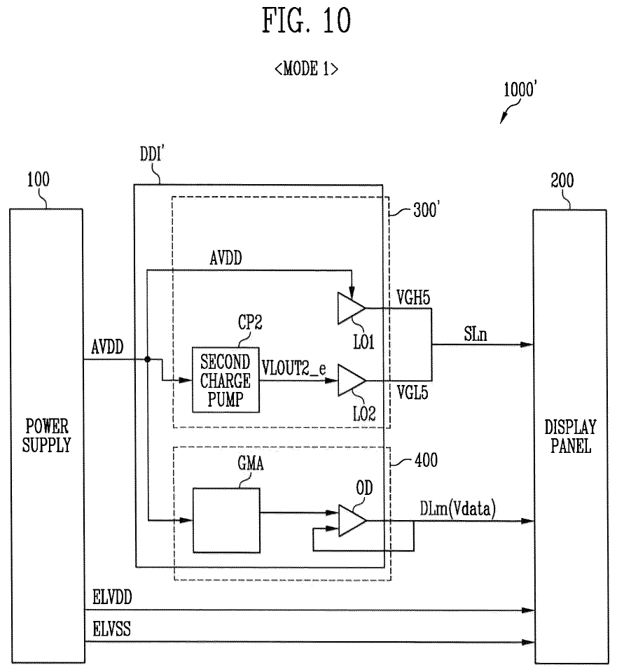

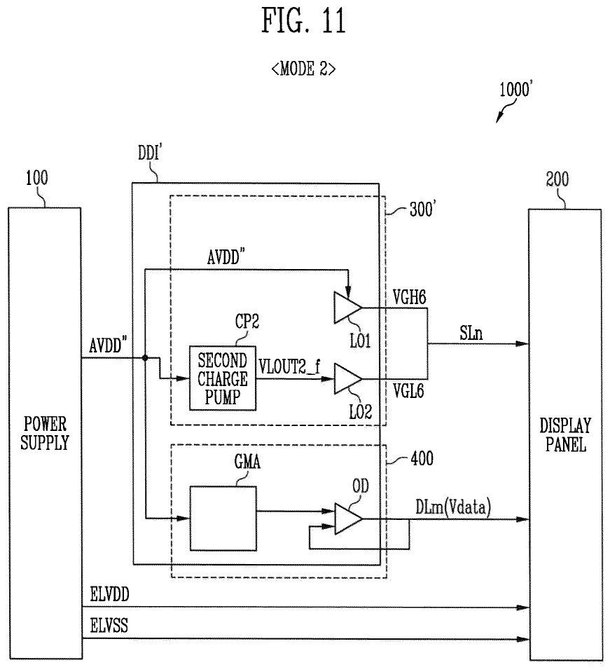

FIG. 10 is a block diagram showing the display device 1000 of FIG. 1 according to an embodiment operating in a first mode. FIG. 11 is a block diagram showing the display device 1000 of FIG. 1 according to an embodiment operating in a second mode.

Referring to FIGS. 10 and 11, the display device 1000′ may include a power supply 100, a data driver DDI′, and a display panel 200. The power supply 100 and the display panel 200 of FIGS. 10 and 11 may operate similarly to the power supply 100 and the display panel 200 of FIG. 3. Accordingly, for convenience of explanation, a further description of components and technical aspects previously described with reference to FIG. 3 may be omitted.

Referring to FIG. 10, in the first mode, the power supply 100 may supply a first driving power AVDD to the data driving unit DDI. For example, the power supply 100 may supply the first driving power AVDD to the scan driver 300′ and the data driver 400.

However, this is an example, and embodiments are not limited thereto. For example, in an embodiment, the power supply 100 may supply a driving power OVDD as shown in FIG. 3. However, for convenience of description, the power supply 100 may be described below as outputting the first driving power AVDD or AVDD″.

The data driver DDI′ may include a scan driver 300′ and a data driver 400. The data driver 400 of FIGS. 10 and 11 may operate similarly to the data driver 400 of FIG. 3. Accordingly, a further description of components and technical aspects previously described with reference to FIG. 3 may be omitted.

The scan driver 300′ may include a second pump CP2, a first regulator LO1, and a second regulator LO2.

Referring to FIG. 10, the second pump CP2 may generate a 2_e reference power VLOUT2_e based on the first driving power AVDD. For example, the second pump CP2 may generate the 2_e reference power VLOUT2_e that is a step-up of the first driving power AVDD. According to embodiments, the 2_e reference power VLOUT2_e may have a value that is about negative twice the first driving power AVDD. According to an embodiment, the 2_e reference power VLOUT2_e may have a value that is about negative three times the first driving power AVDD.

The second regulator LO2 may output a fifth low level signal VGL5 based on the 2_e reference power VLOUT2_e. For example, the second regulator LO2 may output a fifth low level signal VGL5 having an absolute value less than the 2_e reference power VLOUT2_e to the n-th scan line SLn. The first regulator LO1 may output a fifth high level signal VGH5 to the n-th scan line SLn based on the first driving power AVDD.

Referring to FIG. 11, in the second mode, the power supply 100 may supply a first driving power AVDD″ to the data driving unit DDI′. At this time, the first driving power AVDD″ of FIG. 11 may have a greater value than the first driving power AVDD of FIG. 10.

Still referring to FIG. 11, the second pump CP2 may generate a 2_f reference power VLOUT2_f based on the first driving power AVDD″. For example, the second pump CP2 may generate a 2_f reference power VLOUT2_f that is a step-up of the first driving power AVDD″. According to embodiments, the 2_f reference power VLOUT2_f may have a value that is about negative twice the first driving power AVDD″. In an embodiment, the 2_f reference power VLOUT2_f may have a value that is about negative three times the first driving power AVDD″.

The second regulator LO2 may output a sixth low level signal VGL6 based on the 2_f reference power VLOUT2_f. For example, the second regulator LO2 may output a sixth low level signal VGL6 having an absolute value less than the 2_f reference power VLOUT2_f to the n-th scan line SLn. The first regulator LO1 may output a sixth high level signal VGH6 to the n-th scan line SLn based on the first driving power AVDD″.

The 2_f reference power VLOUT2_f may have an absolute value greater than the 2_e reference power VLOUT2_e. Accordingly, the sixth low level signal VGL6 may have a greater absolute value than the fifth low level signal VGL5. In other words, the display device 1000′ may display an image with a relatively higher luminance when driven in the second mode than when driven in the first mode.

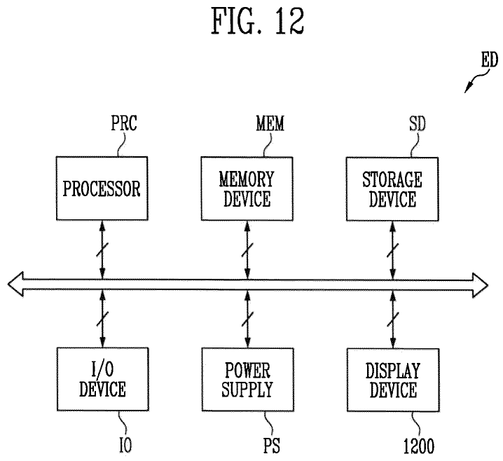

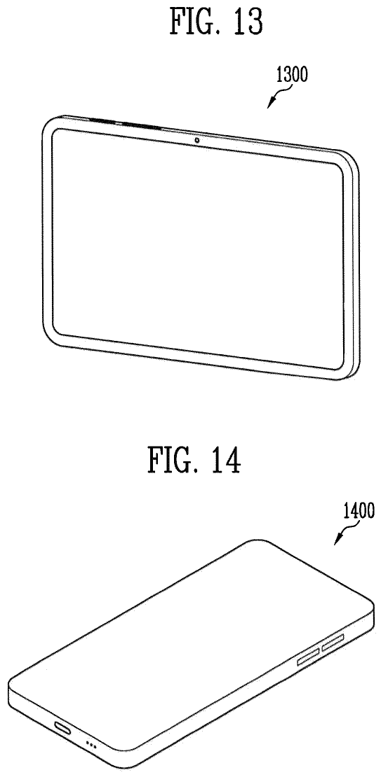

FIG. 12 is a block diagram showing an electronic device including a display device according to embodiments of the present disclosure. FIG. 13 is a perspective view showing an example of the electronic device of FIG. 12 implemented as a tablet personal computer (PC).

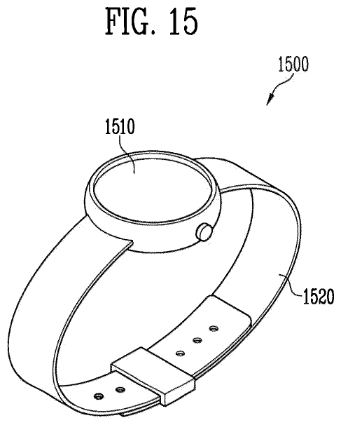

FIG. 14 is a perspective view showing an example of the electronic device of FIG. 12 implemented as a smartphone. FIG. 15 is a perspective view showing an example of the electronic device of FIG. 12 implemented as a smartwatch.

Referring to FIG. 12, the electronic device ED may include a processor PRC, a memory device MEM, a storage device SD, an input/output device IO, a power supply PS, and a display device 1200. The display device 1200 may be, for example, the display device 1000 of FIG. 1. Additionally, the electronic device ED may further include a plurality of ports to communicate with a video card, a sound card, a memory card, a universal serial bus (USB) device, or to communicate with other systems. In an embodiment, the electronic device ED may be implemented as a tablet PC. However, this is an example and the electronic device ED is not limited thereto. For example, according to embodiments, the electronic device ED may be implemented as a mobile phone, a video phone, a smart pad, a smartwatch, an in-car navigation device, a computer monitor, a laptop, a head-mounted display device, etc.

The processor PRC may perform specific calculations or tasks. According to the embodiment, the processor PRC may be, for example, a microprocessor, a central processing unit, an application processor, etc. The processor PRC may be connected to other components through, for example, an address bus, a control bus, a data bus, etc. According to the embodiment, the processor PRC may also be connected to an expansion bus, such as a peripheral component interconnect (PCI) bus.

The memory device MEM may store data utilized for the operation of the electronic device ED. For example, the memory device MEM may include a non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. and/or a volatile memory device, such as a dynamic random access memory (DRAM) device, a static random access memory (SRAM) device, or a mobile DRAM device.

The storage devices SD may include, for example, a solid state drives (SSD), a hard disk drive (HDD), a compact disc read only memory (CD-ROM), etc.

The input/output devices IO may include input means such as, for example, a keyboard, a keypad, a touchpad, a touchscreen, a mouse, etc., and output means such as, for example, a speaker, a printer, etc. According to an embodiment, the display device 1200 may be included in the input/output device IO.

The power supply PS may supply power utilized for the operation of the electronic devices ED. For example, the power supply PS may be a power management integrated circuit (PMIC). According to an embodiment, the power supply PS may be disposed outside the display device 1200 as shown in FIG. 11. The power supply PS may operate in the same manner as the power supply 100 of FIG. 1. However, operation of the power supply PS is not limited thereto.

The display device 1200 may display an image corresponding to visual information of the electronic device ED. The display device 1200 may be, but is not limited to, an organic light emitting display device or a quantum dot light emitting display device. The display device 1200 may be connected to other components through the buses or other communication links.

Referring to FIG. 13, unnecessary power loss of a tablet PC 1300 including the display device according to embodiments of the present disclosure may be reduced and the quality of a displayed image may be improved.

Referring to FIG. 14, unnecessary power loss of a smartphone 1400 including the display device according to embodiments of the present disclosure may be reduced and the quality of a displayed image may be improved.

Referring to FIG. 15, the electronic device ED of FIG. 12 may be applied to a smartwatch 1500 including a display part 1510 and a strap part 1520.

The smartwatch 1500 may be a wearable electronic device. For example, the smartwatch 1500 may have a structure in which the strap part 1520 is worn on the user's wrist. Here, the display device 1200 of FIG. 12 is applied to the display part 1510, so that image data including, for example, time information may be provided to the user.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A display device, comprising:
a display panel including a plurality of data lines, a plurality of scan lines, and a plurality of power lines;
a data driving circuit including a data driver configured to output a data signal and a scan driver configured to output a scan signal; and
a power supply configured to supply a power voltage to the display panel through the power lines, to supply a first driving power to the data driving circuit in a first mode, and to supply the first driving power and a second driving power to the data driving circuit in a second mode different from the first mode.

2. The display device of claim 1, wherein
the scan driver is configured to generate a first reference power and a second reference power based on the first driving power in the first mode, and generate the first reference power and the second reference power based on the first driving power and the second driving power in the second mode.

3. The display device of claim 2, wherein the scan driver includes:
a first pump configured to output the first reference power; and
a second pump configured to output a second reference power having a same absolute value as the first reference power.

4. The display device of claim 3, wherein
the first reference power is a sum of about twice the first driving power and the second driving power.

5. The display device of claim 2, wherein
the power supply is further configured to gradually change absolute values of the first reference power and of the second reference power at predetermined time intervals.

6. The display device of claim 5, wherein
the absolute values of the first reference power and the second reference power change as the second driving power increases at the predetermined time intervals.

7. The display device of claim 6, wherein
each predetermined time interval is one frame.

8. The display device of claim 1, wherein
an absolute value of the second driving power is less than an absolute value of the first driving power.

9. The display device of claim 1, wherein the data driver includes:
a lookup table configured to store a plurality of gamma voltages corresponding to a luminance range of an image output by the display panel; and
a gamma voltage generation circuit configured to select one of the gamma voltages and output the selected gamma voltage as the data signal.

10. The display device of claim 9, wherein
the gamma voltage generation circuit includes first to n-th gamma voltage generators corresponding to n (where n is an integer greater than or equal to 1) luminance ranges, respectively.

11. A display device, comprising:
a display panel including a plurality of data lines, a plurality of scan lines, and a plurality of power lines;
a data driving circuit including a data driver configured to output a data signal and a scan driver configured to output a scan signal; and
a power supply configured to supply a power voltage to the display panel through the power lines and supply a driving power to the data driving circuit,
wherein the scan driver includes a first pump and a second pump configured to output a first reference power and a second reference power, respectively, based on the driving power.

12. The display device of claim 11, wherein
the first pump is configured to output the first reference power to have a value that is about twice the driving power in a first mode, and output the first reference power to have a value that is about three times the driving power in a second mode different from the first mode.

13. The display device of claim 12, wherein
the second pump is configured to output the second reference power to have a value that is about negative twice the driving power in the first mode, and output the second reference power to have a value that is about negative three times the driving power in the second mode.

14. The display device of claim 11, wherein
the power supply is further configured to control the driving power in a first mode to be less than the driving power in a second mode different from the first mode.

15. An electronic device, comprising:
a display device; and
a power supply configured to provide power to the display device,
wherein the display device comprises:
a display panel including a plurality of data lines, a plurality of scan lines, and a plurality of power lines;
a data driving circuit including a data driver configured to output a data signal and a scan driver configured to output a scan signal; and
a power supply configured to supply a power voltage to the display panel through the power lines and supply a first driving power to the data driving circuit, and to change the first driving power in a first mode and the first driving power in a second mode different from the first mode,
wherein the scan driver includes:
a first regulator configured to output a high level signal of the scan signal based on the first driving power; and
a second pump configured to output a reference power based on the first driving power.

16. The electronic device of claim 15, wherein the scan driver further includes:
a second regulator configured to output a low level signal of the scan signal based on the reference power.

17. The electronic device of claim 16, wherein
the high level signal has an absolute value less than the first driving power, and
the low level signal has an absolute value less than the reference power.

18. The electronic device of claim 17, wherein
the power supply is further configured to control the first driving power to be greater in the second mode than in the first mode.
